(19) United States
(12) Patent Application Publication
(10) Pub. No.: US 2020/0238990 A1
(43) Pub. Date: Jul. 30, 2020

(54) ELECTRIC ASSISTED SEMI-TRAILER WITH SMART KINGPIN SENSOR ASSEMBLY

(71) Applicant: Ten-D Energies, Inc., Mercer Island, WA (US)

(72) Inventors: Michael Ma, Redmond, WA (US); Christopher Fraser, Renton, WA (US)

(21) Appl. No.: 16/521,449

(22) Filed: Jul. 24, 2019

Related U.S. Application Data
(60) Provisional application No. 62/798,302, filed on Jan. 29, 2019.

(51) Int. Cl. B60W 30/18; B62D 59/04; B62D 53/08; B60W 10/08; B60W 10/18; G01D 5/14

(52) U.S. Cl. CPC B60W 30/18; B62D 59/04; B62D 53/0842; B60L 50/40; B60W 10/18; G01D 5/145; B60W 10/08

(57) ABSTRACT

A trailer for use with a towing vehicle having a first connector. The trailer includes a connector assembly, a plurality of wheels, and a trailer assist assembly. The connector assembly includes a second connector and at least one sensor. The second connector is configured to be coupled to the first connector to thereby couple the trailer to the towing vehicle. The at least one sensor is configured to detect forces applied to at least a portion of the connector assembly. The trailer assist assembly includes a control system and at least one electric motor. The control system is configured to control operation of the at least one electric motor, receive sensor signals from the at least one sensor, and use the sensor signals to determine when to operate the at least one electric motor. The at least one electric motor is operable to drive the plurality of wheels.

### CROSS REFERENCE TO RELATED APPLICATION(S)

This application claims the benefit of U.S. Provisional Application No. 62/798,302, filed on Jan. 29, 2019, which is incorporated herein by reference in its entirety.

### BACKGROUND OF THE INVENTION

### Field of the Invention

The present invention is directed generally to semi-trailers configured to be towed behind a semi-truck and/or semi-tractor.

### Description of the Related Art

Currently, fuel totals about 39% of the annual operating expenses of a semi-truck, which are about $180,000.00. This means that fuel contributes about $70,200.00 to the total costs of operating the semi-truck. Currently, diesel fuel costs about $2.72 per gallon (in Seattle, Wash. as of May 1, 2018). Thus, about 25,808.82 gallons of diesel fuel are burned per year. If the average semi-truck travels about 130,000 miles per year, on average, a semi-truck typically burns fuel at a rate of about $0.54 per mile. Not only is operating semi-trucks expensive, it also results in high levels of air pollution (e.g., in cities and towns). Therefore, methods and devices configured to lower operational costs, improve safety, and/or reduce engine emissions are desirable.

### BRIEF DESCRIPTION OF THE SEVERAL VIEWS OF THE DRAWING(S)

FIG. 1 is a block diagram illustrating an underside of an articulated vehicle that includes a towing vehicle and a trailer.

FIG. 2 is a block diagram illustrating the underside of the towing vehicle pulling the trailer and turning to the right.

FIG. 3 is a block diagram illustrating the underside of the towing vehicle and the trailer skidding.

FIG. 4 is a block diagram illustrating the underside of the towing vehicle and the trailer jackknifed.

FIG. 5 is a perspective view of an embodiment of the trailer.

FIG. 6A is a perspective view of an embodiment of a kingpin assembly.

FIG. 6B is an exploded perspective view of the kingpin assembly of FIG. 6A.

FIG. 6C is a partially exploded side cross-sectional view of the kingpin assembly illustrated to the left of a side cross-sectional view of the kingpin assembly.

FIG. 6D is a block diagram illustrating some of the internal components of the kingpin assembly.

FIG. 7 is a perspective view of an underside of the kingpin assembly illustrated with load cells.

FIG. 8 is a block diagram illustrating components of a trailer assist assembly.

FIG. 9 is a flow diagram of a method performed by a trailer assist control system of the trailer assist assembly of FIG. 8.

FIG. 10 is a diagram of a hardware environment and an operating environment in which the computing devices of the articulated vehicle of FIG. 1 may be implemented.

Like reference numerals have been used in the figures to identify like components.

### DETAILED DESCRIPTION OF THE INVENTION

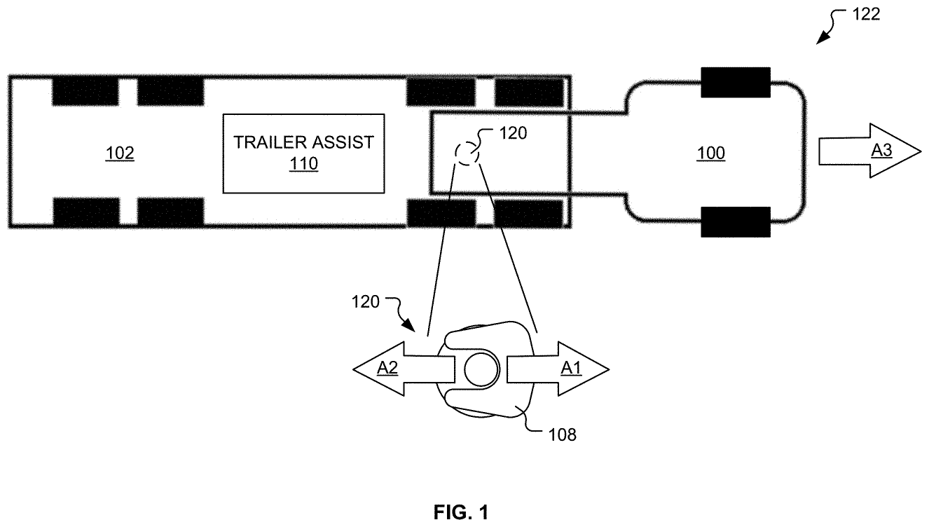

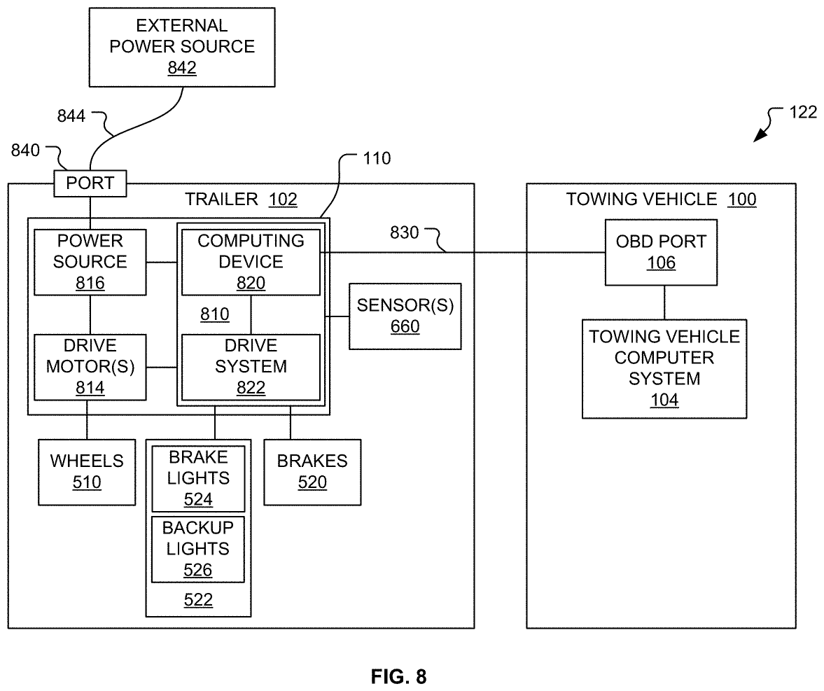

FIG. 1 is a block diagram illustrating an underside of a towing vehicle 100 pulling a trailer 102. The towing vehicle 100 may be implemented as a semi-tractor or semi-truck. The towing vehicle 100 includes a towing vehicle computer system 104 (see FIG. 8) connected to an information port (e.g., an on-board diagnostics (“OBD”) port 106 illustrated in FIG. 8). The towing vehicle 100 also has a first connector (e.g., a fifth wheel hitch 108). The towing vehicle 100 will be described as being operated by a human driver (not shown). However, this is not a requirement and the towing vehicle 100 may implemented as a driverless vehicle. When the towing vehicle 100 is operated as a driverless vehicle, the towing vehicle computer system 104 (see FIG. 8) performs the actions attributed below to the driver.

The trailer 102 includes a trailer assist assembly 110 (described below) configured to help propel the trailer 102 and reduce fuel consumption by the towing vehicle 100. The trailer 102 includes a kingpin assembly 120 configured to be coupled to the fifth wheel hitch 108 of the towing vehicle 100. When the towing vehicle 100 and the trailer 102 are coupled together, they may be characterized as forming an articulated vehicle 122.

An arrow “A1” illustrates a towing vehicle force applied by the towing vehicle 100 to the kingpin assembly 120 and an arrow “A2” illustrates a trailer force applied by the trailer 102 to the kingpin assembly 120. When, as illustrated in FIG. 1, the towing vehicle 100 is pulling the trailer 102 forward and in a straight line, the arrow “A1” illustrates a forwardly directed towing vehicle force and the arrow “A2” illustrates a backwardly directed drag force. Thus, the forces illustrated by arrows “A1” and “A2” are in opposite directions to one another. The forward direction in which the towing vehicle 100 is pulling the trailer 102 is illustrated by an arrow “A3.”

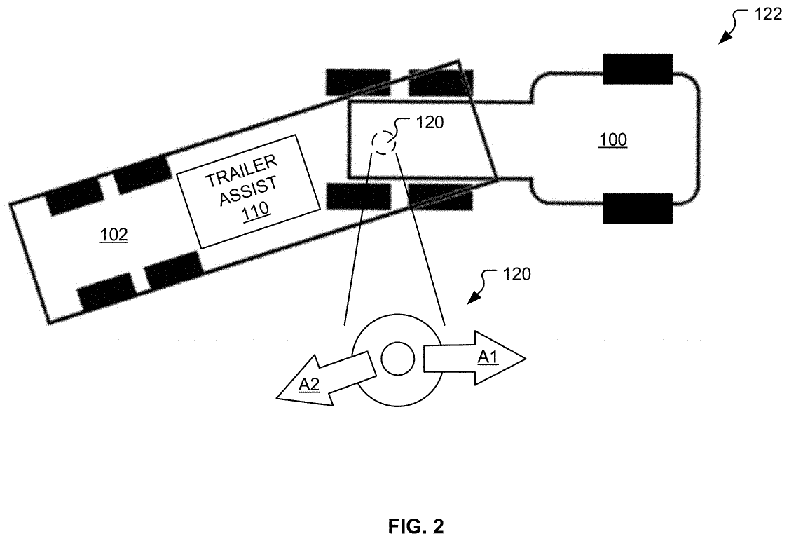

Referring to FIG. 2, when the towing vehicle 100 turns, the kingpin assembly 120 rotates inside and with respect to the fifth wheel hitch 108 (see FIG. 1). As shown in FIG. 2, during a turn, the forces illustrated by arrows “A1” and “A2” are no longer in opposite directions.

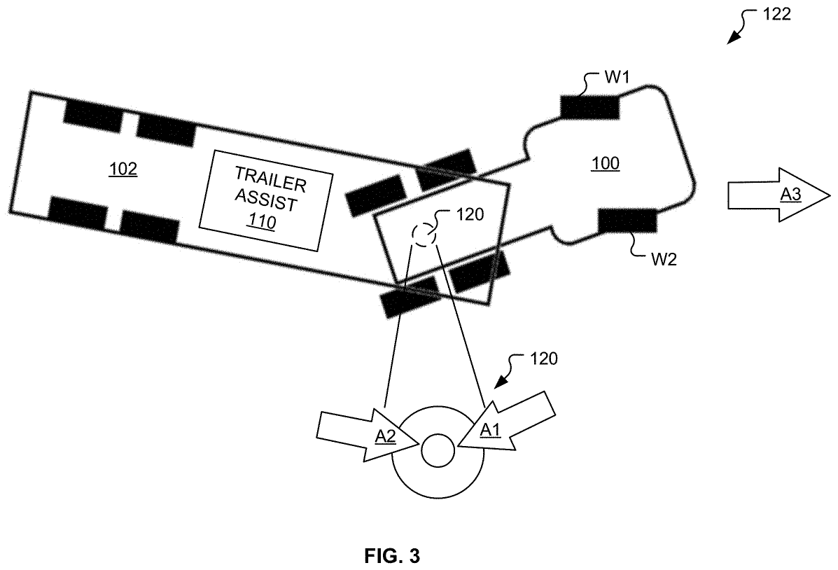

Referring to FIG. 3, when the towing vehicle 100 starts to skid, its front wheels “W1” and “W2” lose traction and start slide. Thus, the driver (not shown) loses the ability to steer the towing vehicle 100 and may begin braking. During the skid, each of the forces illustrated by the arrows “A1” and “A2” may no longer be in opposite directions and at least one of them may be directed toward the kingpin assembly 120. At this point, the driver could regain steering control of the towing vehicle 100 and avoid jackknifing if proper corrective actions are taken by the driver and/or the towing vehicle computer system 104 (see FIG. 8). Jackknifing refers to the folding of an articulated vehicle (e.g., the articulated vehicle 122) so that the articulated vehicle resembles an acute angle of a folding pocket knife.

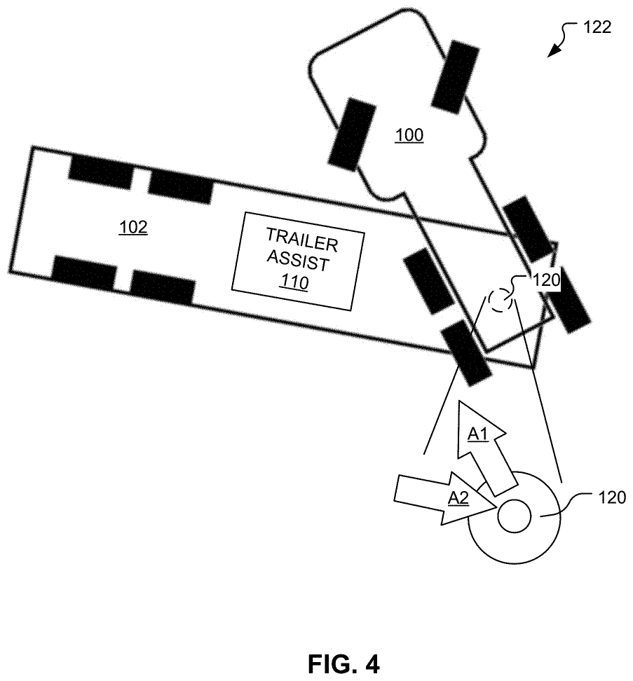

Referring to FIG. 4, if the driver (not shown) continues braking and cannot regain steering control, the articulated vehicle 122 jackknifes. In this configuration, the trailer 102 pushes the towing vehicle 100 (in the direction identified by the arrow “A2”) until the towing vehicle 100 spins around (e.g., and faces backwards) and is pulled by the trailer 102. As shown in FIG. 4, while the articulated vehicle 122 is jackknifed, the towing vehicle 100 is pulled along backwards by the forward movement of the trailer 102. In FIG. 4, the arrow “A1” illustrates a backward directed drag force applied to the kingpin assembly 120 by the towing vehicle 100.

A skid is not the only situation in which the articulated vehicle 122 may jackknife. The towing vehicle 100 and the trailer 102 may jackknife whenever the trailer 102 pushes the towing vehicle 100 forward, particularly, if the towing vehicle 100 is turning or is in the process of slowing down but not fully aligned with the trailer 102 in a straight line. Thus, as will be described below, the kingpin assembly 120 and the trailer assist assembly 110 are configured to help prevent the articulated vehicle 122 from jackknifing when the trailer assist assembly 110 propels the trailer 102 forward and the trailer 102 pushes the towing vehicle 100 forward.

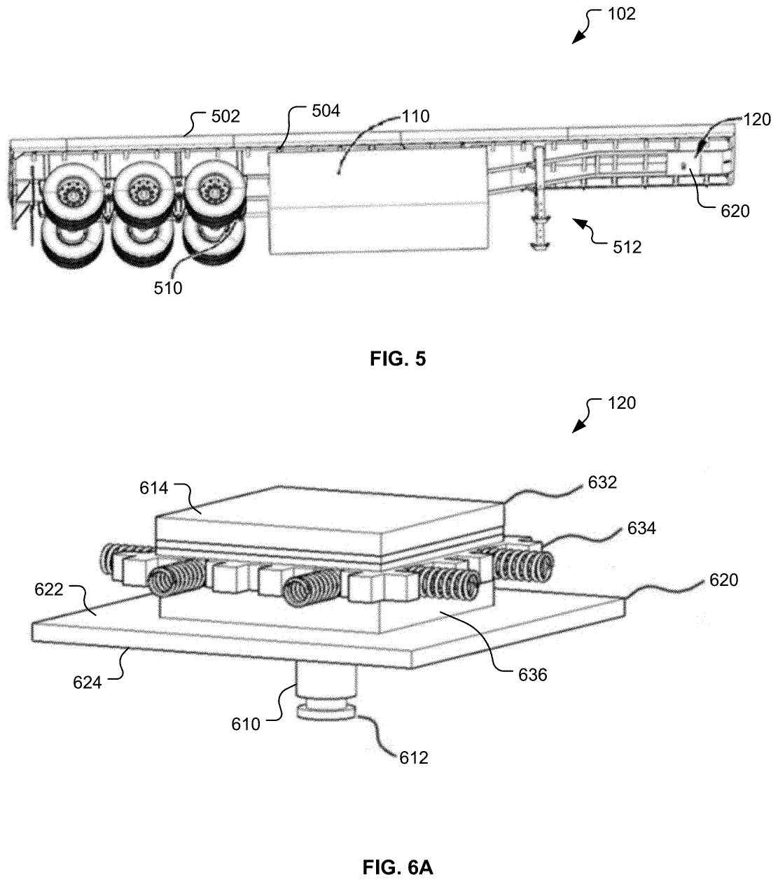

The trailer 102 may be implemented as any type or style of semi-trailer. FIG. 5 illustrates an example in which the trailer 102 is implemented as a flatbed trailer with a bed 502 configured to support cargo (not shown) referred to as a payload. Flatbed semi-trailers, like the one illustrated in FIG. 5, are typically used for hauling and moving large items. In the embodiment illustrated, the trailer assist assembly 110 is coupled to an underside of a trailer frame 504 that supports the bed 502. The trailer frame 504 is at least partially supported by rear trailer wheels 510. When the trailer 102 is disconnected from the towing vehicle 100 (see FIGS. 1-4 and 8), the trailer frame 504 is at least partially supported by one or more trailer jacks 512. The trailer assist assembly 110 is configured to drive the rear trailer wheels 510 causing the rear trailer wheels 510 to rotate and propel the trailer 102 forward and/or backward. Referring to FIG. 8, like many conventional trailers, the trailer 102 has trailer brakes 520 and rearward facing trailer lights 522 that are visible to vehicles and/or people (not shown) positioned behind the trailer 102. The trailer lights 522 include brake lights 524 configured to indicate when the trailer brakes 520 have been activated. The trailer lights 522 also include reverse or backup lights 526 configured to indicate when the towing vehicle 100 is in reverse and/or the trailer 102 is backing up.

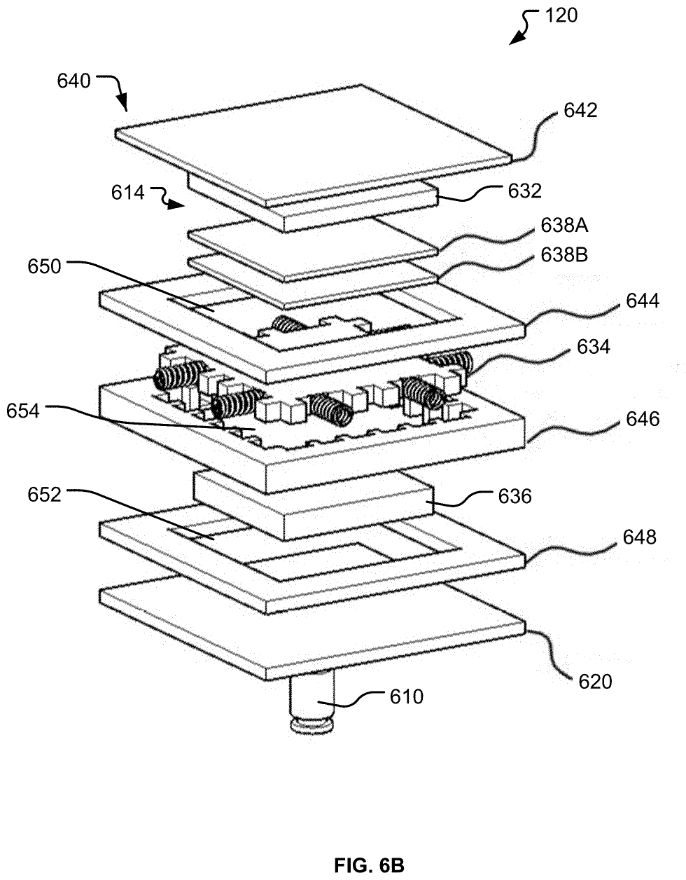

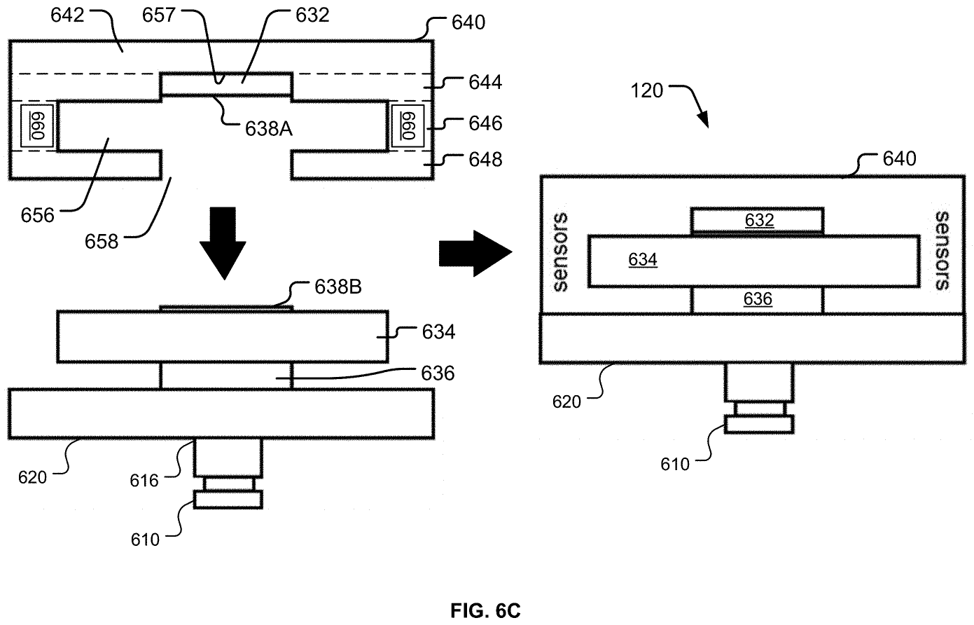

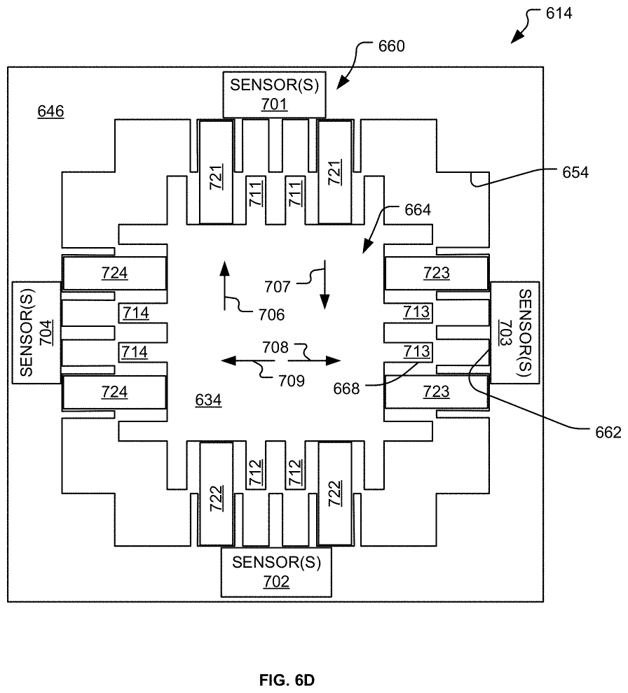

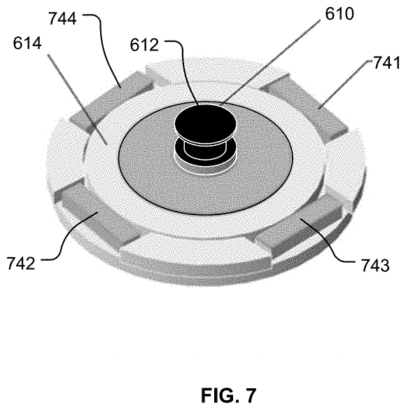

FIG. 6A is a perspective view of the kingpin assembly 120, which includes a standard kingpin 610 affixed to and extending downwardly from a skid plate 620. The kingpin 610 has a free end portion 612 opposite an anchored portion 616 (see FIG. 6C). The free end portion 612 is configured to be received by the fifth wheel hitch 108 (see FIG. 1) of the towing vehicle 100 (see FIGS. 1-4 and 8). The fifth wheel hitch 108 is configured to releasably retain the free end portion 612 to thereby couple the towing vehicle 100 (see FIGS. 1-4 and 8) to the trailer 102 (see FIGS. 1-5 and 8). When the towing vehicle 100 (see FIGS. 1-4 and 8) turns, the fifth wheel hitch 108 (see FIG. 1) rotates around the kingpin 610.

The skid plate 620 has an upward facing surface 622 opposite a downward facing surface 624. The downward facing surface 624 is configured to slide along the fifth wheel hitch 108 (see FIG. 1) of the towing vehicle 100 (see FIGS. 1-4 and 8) when the free end portion 612 is received by the fifth wheel hitch 108. The anchored portion 616 (see FIG. 6C) of the kingpin 610 is permanently affixed to the skid plate 620 with the free end portion 612 being spaced apart from the downward facing surface 624 of the skid plate 620 allowing the free end portion 612 to be received inside the fifth wheel hitch 108 (see FIG. 1).

A mounting plate assembly 614 abuts and is affixed to the skid plate 620. In the embodiment illustrated, the mounting plate assembly 614 is affixed to the upward facing surface 622 of the skid plate 620. The mounting plate assembly 614 includes an upper plate 632, a first sensor plate 634, a base plate 636, and one or more slip materials 638A and 638B (see FIGS. 6B and 6C). Referring to FIG. 6B, in the embodiment illustrated, the slip materials 638A and 638B are sandwiched in between the upper plate 632 and the first sensor plate 634. Referring to FIG. 6C, the slip material 638B is configured to slide along the slip material 638A and vice versa. The upper plate 632 is affixed to the slip material 638A and moves therewith as a unit. The first sensor plate 634 is sandwiched in between the slip material 638B and the base plate 636. The first sensor plate 634 is affixed to the base plate 636 and the slip material 638B and moves therewith as a unit. The base plate 636 is affixed to the upward facing surface 622 of the skid plate 620, and the skid plate 620 is affixed to the anchored portion 616 (see FIG. 7) of the kingpin 610. Thus, the skid plate 620 moves along with the kingpin 610 as a unit and the base plate 636 moves along with the skid plate 620 as a unit. In other words, movement of the kingpin 610 is translated by the skid plate 620 to the base plate 636. The slip materials 638A and 638B may be and/or may include glass-filled polytetrafluoroethylene (“PTFE”), polyglass-filled PTFE, and the like.

Referring to FIG. 6B, the kingpin assembly 120 also includes a sensor enclosure 640 configured to house the mounting plate assembly 614. The sensor enclosure 640 includes a top plate 642, an upper spacer plate 644, a second sensor plate 646, and a lower spacer plate 648. The first sensor plate 634, the base plate 636, and the slip material 638B of the mounting plate assembly 614 move or slide inside the sensor enclosure 640. The top plate 642 of the sensor enclosure 640 is affixed to an underside of the trailer 102. Thus, the kingpin 610 is coupled to the towing vehicle 100 (and the trailer 102) and the sensor enclosure 640 is coupled to and extends downwardly from the underside of the trailer 102. As explained above, the skid plate 620 (with the kingpin 610 affixed thereto) is coupled to the base plate 636 of the mounting plate assembly 614 and causes the first sensor plate 634, the base plate 636, and the slip material 638B to move with respect to the sensor enclosure 640. At the same time, the sensor enclosure 640 extends downwardly from the underside of the trailer 102 and is movable with respect to the first sensor plate 634, the base plate 636, and the slip material 638B of the mounting plate assembly 614.

The top plate 642 is positioned above and is affixed to the upper plate 632. Thus, the upper plate 632 and the slip material 638A are affixed to the sensor enclosure 640 and move therewith as a unit. The upper spacer plate 644 is sandwiched in between the top plate 642 and the second sensor plate 646. The upper spacer plate 644 has an upper through-hole 650. The upper plate 632 and the slip materials 638A and 638B of the mounting plate assembly 614 are configured to be positioned inside the upper through-hole 650. The slip material 638B is movable inside the upper through-hole 650 with respect to the sensor enclosure 640.

The lower spacer plate 648 is positioned below the second sensor plate 646 and above the skid plate 620. The lower spacer plate 648 may rest on the skid plate 620. The lower spacer plate 648 has a lower through-hole 652. The base plate 636 is configured to be positioned inside the lower through-hole 652. The base plate 636 is movable inside the lower through-hole 652 with respect to the sensor enclosure 640.

The second sensor plate 646 is positioned in between the upper and lower spacer plates 644 and 648. The second sensor plate 646 has a through-hole 654 configured to receive the first sensor plate 634. The first sensor plate 634 is movable or slideable inside the through-hole 654 with respect to the second sensor plate 646 of the sensor enclosure 640.

When the sensor enclosure 640 is assembled, the through-holes 650-654 define an open-ended through-channel 656 (see FIG. 6C) inside the sensor enclosure 640. Referring to FIG. 6C, an upper opening 657 of the open-ended through-channel 656 is closed by the top plate 642. A lower end opening 658 of the open-ended through-channel 656 may abut and be closed by the skid plate 620. The first sensor plate 634, the base plate 636, and the slip material 638B are movable inside the open-ended through-channel 656 with respect to the sensor enclosure 640.

The first sensor plate 634, the base plate 636, and the slip material 638B may slide freely with respect to the top plate 642 of the sensor enclosure 640. As mentioned above, the upper plate 632 and the slip material 638A may be affixed to the top plate 642 and may move therewith as a unit. In other words, the sensor enclosure 640 moves with respect to the kingpin 610 (with the skid plate 620 affixed thereto), the base plate 636, the first sensor plate 634, and the slip material 638B. At the same time, the kingpin 610 (with the skid plate 620 affixed thereto), the base plate 636, the first sensor plate 634, and the slip material 638B may move with respect to the sensor enclosure 640.

FIG. 6D is a block diagram illustrating the first sensor plate 634 positioned inside the through-hole 654 of the second sensor plate 646. Referring to FIG. 6D, the mounting plate assembly 614 includes one or more sensors 660 positioned on the first sensor plate 634 and/or the second sensor plate 646. In the example illustrated, the sensor(s) 660 are mounted along an inside edge 662 of the through-hole 654 of the second sensor plate 646. In the embodiment illustrated, the sensor(s) 660 include sensors 701-704.

The mounting plate assembly 614 includes one or more magnets 664 positioned on the first sensor plate 634 and/or the second sensor plate 646. In the example illustrated, the magnet(s) 664 are mounted along a periphery 668 of the first sensor plate 634. Each of the sensor(s) 660 is positioned near a corresponding one or more of the magnet(s) 664 and is configured to detect a strength (or magnitude) of a magnetic field emanating from the corresponding magnet(s). In the embodiment illustrated, the magnet(s) 664 include magnets 711-714. Each of the magnets 711-714 may be implemented as one or multiple magnets, one or more magnetic materials, one or more materials that has been magnetized, and the like. The sensors 701-704 are mounted near the magnets 711-714, respectively. The magnets 711-714 are positioned to be detected by the sensors 701-704, respectively.

The sensor(s) 660 are linked to the trailer 102 by the top plate 642 (see FIGS. 6B and 6C) and the magnet(s) 664 are linked to the kingpin 610 and the skid plate 620 (see FIGS. 5 and 6A-6C) by the base plate 636 (see FIGS. 6A-6C). The sensor(s) 660 may be arranged as an array or in a grid pattern. For example, the second sensor plate 646 may be lattice or grid shaped and configured to position the sensor(s) 660 (see FIGS. 6C and 6D) in a grid pattern. The sensor(s) 660 illustrated include the one or more front sensors 701, the one or more rear sensors 702, the one or more first side sensors 703, and the one or more second side sensors 704. The front and rear sensors 701 and 702 may be positioned to sense along first and second directions (illustrated by arrows 706 and 707, respectively) and the first and second side sensors 703 and 704 may be positioned to sense along third and fourth directions (illustrated by arrows 708 and 709, respectively). The first direction may be opposite the second direction and the third direction may be opposite the fourth direction. The first and second directions may be orthogonal to the third and fourth directions. For example, the first direction may be toward the towing vehicle 100 (see FIGS. 1-4 and 8) and the second direction may be away from the towing vehicle 100. The third direction may be toward a passenger side of the towing vehicle 100 (see FIGS. 1-4 and 8) and the fourth direction may be toward a driver side of the towing vehicle 100. By way of a non-limiting example, the sensors 701-704 may be implemented as four Hall Effect sensors. Such Hall Effect sensors may be configured to last millions of cycles and provide both longevity and repeatability.

One or more springs 721 space the magnet(s) 711 apart from the front sensor(s) 701 and one or more springs 722 space the magnet(s) 712 apart from the rear sensor(s) 702. In other words, the spring(s) 721 bias the magnet(s) 711 away from the front sensor(s) 701 and the spring(s) 722 bias the magnet(s) 712 away from the rear sensor(s) 702. In the embodiment illustrated, the spring(s) 721 and the spring(s) 722 move along the first and second directions (illustrated by the arrows 706 and 707, respectively).

One or more springs 723 space the magnet(s) 713 apart from the first side sensor(s) 703 and one or more springs 724 space the magnet(s) 714 apart from the second side sensor(s) 704. In other words, the spring(s) 723 bias the magnet(s) 713 away from the first side sensor(s) 703 and the spring(s) 724 bias the magnet(s) 714 away from the second side sensor(s) 704. In the embodiment illustrated, the spring(s) 723 and the spring(s) 724 move along the third and fourth directions (illustrated by the arrows 708 and 709, respectively).

As mentioned above, the first sensor plate 634 may slide freely inside the through-hole 654 with respect to the second sensor plate 646. The springs 721-724 compress when force is applied to them as the first sensor plate 634 slides with respect to the second sensor plate 646. For example, the magnet(s) 711 move(s) closer to the front sensor(s) 701 when the spring(s) 721 is/are compressed and farther away from the front sensor(s) 701 when the spring(s) 721 is/are no longer compressed. Thus, the magnet(s) 711 move(s) in the first direction closer to the front sensor(s) 701 when the spring(s) 721 is/are compressed and move(s) in the second direction farther away from the front sensor(s) 701 when the spring(s) 721 is/are no longer compressed. The front sensor(s) 701 detect(s) a first strength (or magnitude) of a first magnet field that depends on a first distance between the front sensor(s) 701 and the magnet(s) 711. Optionally, the front sensor(s) 701 may determine the first distance.

Similarly, the magnet(s) 712 move(s) in the second direction closer to the rear sensor(s) 702 when the spring(s) 722 is/are compressed and move(s) in the first direction farther away from the rear sensor(s) 702 when the spring(s) 722 is/are no longer compressed. The rear sensor(s) 702 detect(s) a second strength (or magnitude) of a second magnet field that depends on a second distance between the rear sensor(s) 702 and the magnet(s) 712. Optionally, the rear sensor(s) 702 may determine the second distance.

The magnet(s) 713 move(s) in the third direction closer to the first side sensor(s) 703 when the spring(s) 723 is/are compressed and move(s) in the fourth direction farther away from the first side sensor(s) 703 when the spring(s) 723 is/are no longer compressed. The first side sensor(s) 703 detect(s) a third strength (or magnitude) of a third magnet field that depends on a third distance between the first side sensor(s) 703 and the magnet(s) 713. Optionally, the first side sensor(s) 703 may determine the third distance.

Additionally, the magnet(s) 714 move(s) in the fourth direction closer to the second side sensor(s) 704 when the spring(s) 724 is/are compressed and move(s) in the third direction farther away from the second side sensor(s) 704 when the spring(s) 724 is/are no longer compressed. The second side sensor(s) 704 detect(s) a fourth strength (or magnitude) of a fourth magnet field that depends on a fourth distance between the second side sensor(s) 704 and the magnet(s) 714. Optionally, the second side sensor(s) 704 may determine the fourth distance.

The first distance determines how much force is being applied to the kingpin 610 (and the skid plate 620) along the first direction, the second distance determines how much force is being applied to the kingpin 610 (and the skid plate 620) along the second direction, the third distance determines how much force is being applied to the kingpin 610 (and the skid plate 620) along the third direction, and the fourth distance determines how much force is being applied to the kingpin 610 (and the skid plate 620) along the fourth direction. Thus, the sensors 701-704 may detect and/or indicate in which direction force(s) is/are being applied to the kingpin 610 (and the skid plate 620). Additionally, the first, second, third, and fourth distances may be used to determine a magnitude of those force(s). For example, the magnitude may be determined using a spring force equation (e.g., Hooke's Law), which may optionally be modified (e.g., using machine learning). Hooke's Law determines an amount of force required to deform a spring by multiplying the deformation (e.g., one of the first, second, third, and fourth distances) by a constant that is characteristic of the stiffness of the spring.

The sensors 701-704 are configured to send sensor signals to the trailer assist assembly 110 (see FIGS. 1-5 and 8). The sensor signals may encode the first, second, third, and fourth distances between the magnets 711-714, respectively, and the sensors 701-704, respectively. By way of yet another non-limiting example, the sensor signals may encode the first, second, third, and fourth strengths of the first, second, third, and fourth magnet fields, respectively, detected by the sensors 701-704, respectively. The trailer assist assembly 110 (see FIGS. 1-5 and 8) uses the sensor signals to determine the direction and magnitude of the force(s) being applied to the kingpin 610 (and the skid plate 620) by the towing vehicle 100 and/or the trailer 102. The direction and magnitude of the force(s) being applied to the kingpin 610 (and the skid plate 620) will be referred to as force vector(s). However, this information need not be represented by one or more vectors. By way of non-limiting examples, the force vector(s) are illustrated in FIGS. 1-4 by the arrows “A1” and “A2.” The force vector(s) may be determined by compiling the spring force equation (e.g., Hooke's Law) across the different springs 721-724.

Referring to FIG. 7, initially, load cells 741-744 may be used to calibrate the sensors 701-704 (see FIG. 6D), respectively, to their respective spring forces. The load cells 741-744 are resistive elements placed in each direction in which the sensors 701-704, respectively, are oriented along the second sensor plate 646 (see FIGS. 6B-6D).

Referring to FIG. 8, the trailer assist assembly 110 includes a trailer assist control system 810, one or more drive motors 814, and a power source 816. In the embodiment illustrated, the trailer assist control system 810 includes a computing device 820 and a drive system 822. The sensor(s) 660 send sensor signals to the trailer assist control system 810, which is configured to control the drive motor(s) 814. Optionally, the trailer assist control system 810 (e.g., the computing device 820) may be connected the OBD port 106 by a connection 830. In such embodiments, the computing device 820 may obtain data from the OBD port 106 and use that data to assist the drive system 822. The data collected from the OBD port 106 may include, for example, accelerator pedal deflection, brake pedal deflection, engine revolutions per minute (“RPM”), speed, direction of the towing vehicle 100, and the like. This additional data is useful because the drive motor(s) 814 has/have no understanding of the payload (e.g., on the bed 502 illustrated in FIG. 5) supported by the trailer 102. The drive system 822 may include one or more circuits (not shown) configured to control the drive motor(s) 814.

As mentioned above, the sensor(s) 660 (e.g., the sensors 701-704 illustrated in FIG. 6D) send sensor signals to the trailer assist control system 810, which is configured to control the drive motor(s) 814. The trailer assist control system 810 receives the sensor signals and determines the force vector(s) being applied to the kingpin 610 (see FIGS. 6A-6C and 7) and the skid plate 620 (see FIGS. 5-6C) by the towing vehicle 100 and/or the trailer 102 based on information encoded in the sensor signals. The trailer assist control system 810 uses the force vector(s) to determine when and how much power the drive motor(s) 814 applies to the rear trailer wheels 510. The trailer assist control system 810 ensures that the towing vehicle 100 and the trailer 102 are in sync when the articulated vehicle 122 speeds-up and/or slows-down. The trailer assist control system 810 may use the sensor signals to determine when the trailer 102 needs to apply differential braking, which may help increase overall vehicle safety.

The trailer assist control system 810 uses the sensor signals received from the sensor(s) 660 to detect whether the towing vehicle 100 is dragging or pulling the trailer 102, and to detect that the towing vehicle 100 is not being pushed by the trailer 102. The trailer assist control system 810 may also use the sensor signals to determine when adjustments would help prevent the trailer 102 from jackknifing. In other words, the sensor(s) 660 provide(s) information to the trailer assist control system 810 necessary for the trailer assist control system 810 to generate and/or maintain a suitable push-pull combination. For example, the trailer assist control system 810 may use the sensor signals to determine an amount of propulsion force needed and instruct the drive motor(s) 814 to apply that amount of propulsion force to the rear trailer wheels 510. Similarly, the trailer assist control system 810 may use the sensor signals to determine an amount of braking force needed and instruct the drive motor(s) 814 and/or the trailer brakes 520 to apply that amount of braking force to the rear trailer wheels 510. For example, to slow the articulated vehicle 122, the trailer assist control system 810 may instruct the drive motor(s) 814 to engage regenerative braking, which captures kinetic energy from the rear trailer wheels 510 slowing the articulated vehicle 122, uses the kinetic energy to generate electrical energy, and uses the electric energy to charge the power source 816.

The power source 816 may be implemented as one or more batteries (e.g., one or more rechargeable batteries) and/or one or more capacitors (e.g., one or more super-capacitors). The power source 816 may be connected to a recharging port 840 configured to receive power from an external power source 842 and provide that power to the power source 816. The recharging port 840 may be configured to be connected to the external power source 842 by a connection 844. The power source 816 is configured to power the drive motor(s) 814, the sensor(s) 660, and the trailer assist control system 810. Thus, the power source 816 is configured to power the trailer 102. The external power source 842 may be implemented as a convention power grid. In such embodiments, the connection 844 may be implemented as a power cord. Thus, the trailer assist assembly 110 may be configured to be plugged into the power grid, which provides electricity to charge the power source 816. The power source 816 is configured to power the drive motor(s) 814, which supply a locomotive force to the rear trailer wheels 510 of the trailer 102.

The power source 816 powers the drive motor(s) 814, so power used to move the articulated vehicle 122 does not come solely from the towing vehicle 100 (e.g., from its diesel engine, electric motor, and the like) alone. In other words, the trailer assist assembly 110 may turn the towing vehicle 100 into a hybrid/diesel powered semi-truck when the towing vehicle 100 is a diesel powered semi-truck and the trailer 102 is attached the towing vehicle 100 by the kingpin assembly 120 (see FIGS. 1-6C). The additional power provided by the drive motor(s) 814 may be particularly helpful when the towing vehicle 100 is driving at low speeds (e.g., in start-and-stop traffic) and/or driving uphill where additional torque is needed.

As mentioned above, the trailer assist control system 810 may use the sensor signals to determine when adjustments would help prevent the trailer 102 from jackknifing. The trailer assist control system 810 may monitor the sensor signals for forces that indicate jackknifing is likely to occur and apply corrective braking and/or corrective propulsion to prevent the jackknife from occurring. For example, if the trailer 102 is un-powered, corrective braking may be the only adjustment made by the trailer assist control system 810. On the other hand, if the trailer 102 is powered, the trailer assist control system 810 may use corrective braking and/or corrective propulsion to make adjustments. The trailer assist control system 810 may also monitor the sensor signals to detect turning motions (or rotation) and vehicle speed to determine whether the corrective braking is safe and/or likely to help prevent jackknifing. If the trailer assist control system 810 determines corrective braking is unsafe and/or unlikely to prevent jackknifing, the trailer assist control system 810 may decide not to apply the corrective braking. In other words, the trailer assist control system 810 may determine the force vector(s) being applied to the kingpin 610 (and the skid plate 620) and use those force vector(s) to assist the driver with regard to handling the load being towed by the towing vehicle 100. For example, the trailer assist assembly 110 may help avoid jackknifing and/or skidding, both of which are dangerous. If the trailer 102 begins to spin, skid, or jackknife, the sensor(s) 660 will detect this and the trailer assist control system 810 may apply braking and/or take corrective actions to maintain safety. For example, the trailer assist control system 810 may turn off the drive motor(s) 814.

As mentioned above, the trailer assist control system 810 and the drive motor(s) 814 may implement engage regenerative braking. When the articulated vehicle 122 needs to slow down, the drive motor(s) 814 may be used to provide additional braking power by recapturing kinetic energy, which would otherwise be lost, and using the recaptured kinetic energy to charge the power source 816. This extra braking power not only increases vehicle safety, but also reduces wear-and-tear on the brakes of the towing vehicle 100 and/or the trailer brakes 520 (e.g., on brake pads of the towing vehicle and/or trailer brakes).

The drive motor(s) 814, powered by the power source 816, may be configured to assist the towing vehicle 100 while towing the trailer 102 to help reduce fuel costs, vehicle emissions, and/or strain on the towing vehicle 100. For example, the trailer assist assembly 110 provides additional locomotive force that may assist the towing vehicle 100 when the towing vehicle 100 is ascending and/or descending steep grades. This may be particularly useful when the towing vehicle 100 is under heavy load or at risk of tire slippage. The trailer assist assembly 110 may help increase the towing power (or torque) of the towing vehicle 100 and/or traction (e.g., like four-wheel drive increases traction over a similar two-wheel drive vehicle).

The trailer assist assembly 110 may effectively lessen the workload of the towing vehicle 100. For example, the trailer assist assembly 110 may be configured to reduce the backwardly directed drag force (illustrated by the arrow “A2” in FIG. 1) that is applied by the trailer 102 to the kingpin assembly 120 (see FIGS. 1-6C). This enables the towing vehicle 100 to haul heavy loads more safely on steep grades and significantly lowers fuel costs. If the power source 816 (e.g., batteries) is depleted while driving, the towing vehicle 100 (e.g., its diesel engine, electric motor, and the like) takes over and the articulated vehicle 122 drives normally and unassisted by the drive motor(s) 814.

In addition to assisting the towing vehicle 100, the drive motor(s) 814, powered by the power source 816, may be configured to move the trailer 102 (e.g., with a pendant in a parking lot) and/or the articulated vehicle 122 without the help of the towing vehicle 100. In other words, the trailer assist assembly 110 may be configured to fully drive the trailer 102 and/or the articulated vehicle 122 with propulsion provided by the drive motor(s) 814 and the power source 816. As used herein, a pendant (not shown) is a remote control device that a person can use to drive the trailer 102. A pendant (not shown) may be connected to the trailer 102 via a wired or wireless connection (not shown). A pendant (not shown) may be used to drive the trailer 102 around within a small or tight areas (e.g., parking lots) without using the towing vehicle 100. However, referring to FIG. 5, the trailer jack(s) 512, if present, may be replaced with one or more pivoting wheels (e.g., casters). The trailer assist assembly 110 may steer the trailer 102 by controlling differential speeds of the rear trailer wheels 510 either by selectively braking one or more of the rear trailer wheels 510, and/or by driving each of the rear trailer wheels 510 independently (e.g., with a separate one of the drive motor(s) 814) forward or in reverse. Thus, the combination of the kingpin assembly 120 and the trailer assist assembly 110 allow the trailer 102 to move itself around (e.g., for a short distance). In this manner, a plurality of trailers like the trailer 102 may reposition themselves (e.g., within a parking lot, at a cross-docking facility, at a dock, and the like). For example, the driver could simply drop the trailer 102 at a recipient's address and leave. When the recipient is ready to unload the trailer 102, the trailer 102 may drive itself to an unload location (e.g., to a dock) without the towing vehicle 100 (see FIGS. 1-4 and 8).

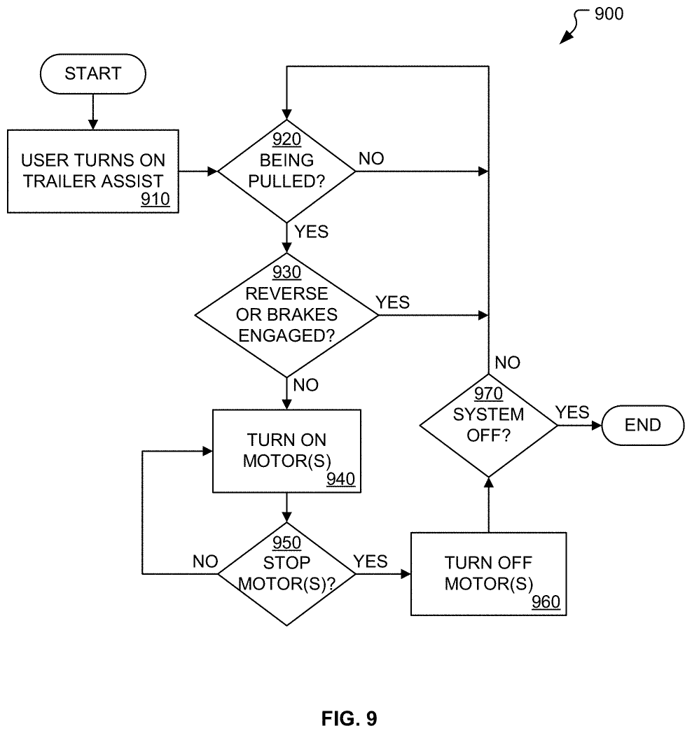

FIG. 9 is a flow diagram of a method 900 performed by the trailer assist control system 810 (see FIG. 8). In first block 910, the trailer assist control system 810 detects that a user (e.g., the driver) has turned on the trailer assist assembly 110 (see FIGS. 1-5 and 8) and/or the trailer assist control system 810. In other words, the user has indicated that the user would like the drive motor(s) 814 (see FIG. 8) to help propel the trailer 102 (see FIGS. 1-5 and 8). Next, in decision block 920, the trailer assist control system 810 determines whether the trailer 102 is being pulled by the towing vehicle 100 (see FIGS. 1-4 and 8). The decision in decision block 920 is “YES,” when the trailer assist control system 810 determines the trailer 102 is being pulled. Otherwise, the decision in decision block 920 is “NO” and the trailer assist control system 810 returns to decision block 920. The trailer assist control system 810 may use the sensor signals received from the sensor(s) 660 to determine the whether the trailer 102 is being pulled by the towing vehicle 100.

When the decision in decision block 920 is “YES,” in decision block 930, the trailer assist control system 810 determines whether (a) the brakes of the towing vehicle 100 and/or the trailer brakes 520 (see FIG. 8) are engaged or (b) the towing vehicle 100 and/or the trailer 102 are in reverse. For example, the trailer assist control system 810 may determine the brakes of the towing vehicle 100 and/or the trailer brakes 520 (see FIG. 8) are engaged when the brake lights of the towing vehicle 100 and/or the brake lights 524 (see FIG. 8) of the trailer 102 are on. Similarly, the trailer assist control system 810 may determine the towing vehicle 100 and/or the trailer 102 are in reverse when the backup lights of the towing vehicle 100 and/or the backup lights 526 (see FIG. 8) of the trailer 102 are on. In such embodiments, when the brake lights and/or the reverse lights are on, the decision in decision block 930 is “YES.” Otherwise, the decision in decision block 930 is “NO.” Thus, the decision in decision block 930 is “YES,” when the trailer assist control system 810 determines the brakes of the towing vehicle 100 and/or the trailer brakes 520 (see FIG. 8) are engaged or at least one of the towing vehicle 100 and/or the trailer 102 is in reverse. Otherwise, the decision in decision block 930 is “NO.”

When the decision in decision block 930 is “YES,” the trailer assist control system 810 returns to decision block 920. On the other hand, when the decision in decision block 930 is “NO,” in block 940, the trailer assist control system 810 turns on the drive motor(s) 814, which help propel the trailer 102 forward.

Next, in decision block 950, the trailer assist control system 810 decides whether to turn off the drive motor(s) 814. The decision in decision block 950 may be “YES” when the trailer assist control system 810 detects the brakes of the towing vehicle 100 and/or the trailer brakes 520 (see FIG. 8) have been applied. Alternatively, the decision in decision block 950 may be “YES” when the trailer assist control system 810 determines at least one of the sensor(s) 660 is sensing an undesirable change in the force(s) at the kingpin assembly 120 (see FIGS. 1-6C) has occurred. For example, the undesirable change may be a significant increase in force at the kingpin assembly 120. By way of a non-limiting example, the significant increase in force may include any increase greater than zero Newtons (“N”). The direction of the increase and/or over how much time the increase occurred may also be taken into consideration. For example, the direction of force and the amount of time may be used by the trailer assist control system 810 in block 940 (see FIG. 9) as parameters that influence left and/or right wheel rotational force(s).

Additionally, the decision in decision block 950 may be “YES” when the trailer assist control system 810 determines the articulated vehicle 122 is about to spin, jackknife, and/or skid.

When the decision in decision block 950 is “NO,” the trailer assist control system 810 returns to block 940 and allows the drive motor(s) 814 to continue operating. On the other hand, when the decision in decision block 950 is “YES,” in block 960, the trailer assist control system 810 turns off the drive motor(s) 814. Turning off the drive motor(s) 814 should help reduce force applied to the kingpin assembly 140 by the trailer 102. Optionally, the trailer assist control system 810 may apply corrective braking if the trailer assist control system 810 determined the articulated vehicle 122 may spin, jackknife, or skid in decision block 950.

In decision block 970, the trailer assist control system 810 determines whether the trailer assist assembly 110 and/or the trailer assist control system 810 has been turned off. The decision in decision block 970 is “YES” when at least one of the trailer assist assembly 110 and the trailer assist control system 810 has been turned off. When the decision in decision block 970 is “YES,” the method 900 terminates. On the other hand, when the decision in decision block 970 is “NO,” the trailer assist control system 810 returns to decision block 920.

### Computing Device

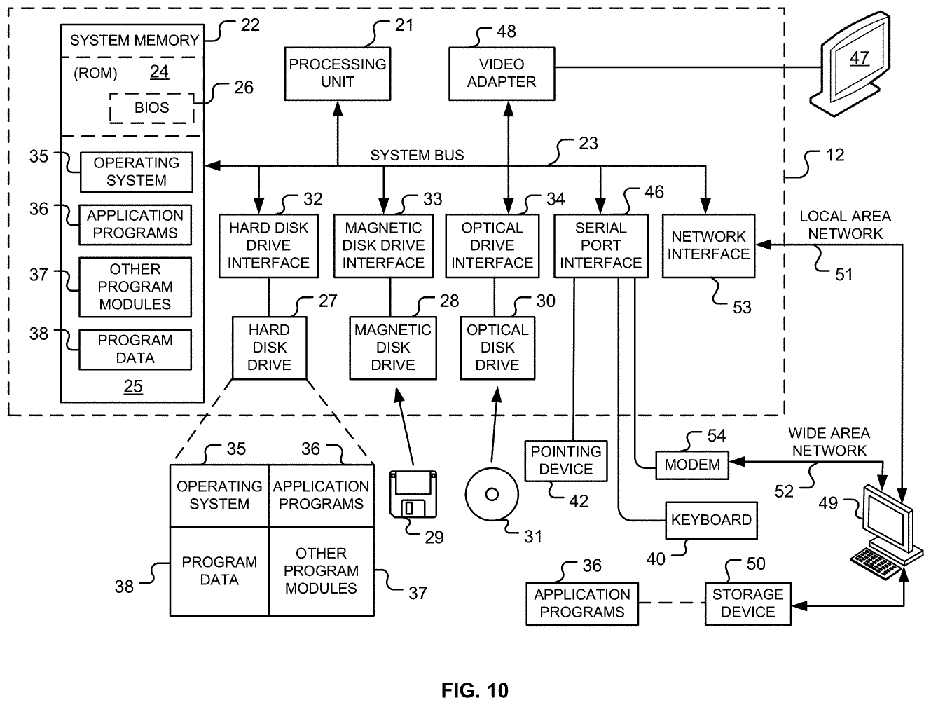

FIG. 10 is a diagram of hardware and an operating environment in conjunction with which implementations of the one or more computing devices of the articulated vehicle 122 (see FIGS. 1-4 and 8) may be practiced. The description of FIG. 10 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

The exemplary hardware and operating environment of FIG. 10 includes a general-purpose computing device in the form of the computing device 12. Each of the computing devices of FIG. 8 (including the towing vehicle computer system 104 and the computing device 820) may be substantially identical to the computing device 12. By way of non-limiting examples, the computing device 12 may be implemented as a laptop computer, a tablet computer, a smartphone, a mobile computing device, a cellular telephone, and the like. The computing device 12 may be a conventional computer, a distributed computer, or any other type of computer. Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The computing device 12 includes a system memory 22, a processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 10 include a local-area network (LAN) 51 and a wide-area network (WAN) 52. Such networking environments are commonplace in offices, enterprise-wide computer networks, intranets and the Internet. Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port).

When used in a LAN-networking environment, the computing device 12 is connected to the local area network 51 through a network interface or adapter 53, which is one type of communications device. When used in a WAN-networking environment, the computing device 12 typically includes a modem 54 (e.g., a cellular data modem), a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 900 illustrated in FIG. 9) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A trailer for use with a towing vehicle comprising a fifth wheel hitch, the trailer comprising:
a kingpin assembly comprising a kingpin and at least one sensor, the kingpin being configured to be received by the fifth wheel hitch to thereby couple the trailer to the towing vehicle, the at least one sensor being configured to detect forces applied to the kingpin;
a plurality of wheels; and
a trailer assist assembly comprising a control system and at least one electric motor, the control system being configured to control operation of the at least one electric motor, receive sensor signals from the at least one sensor, and use the sensor signals to determine when to operate the at least one electric motor, the at least one electric motor being operable to drive the plurality of wheels.

2. The trailer of claim 1, wherein the trailer assist assembly comprises a power source configured to power the control system and the at least one electric motor; and
the power source comprises at least one of batteries and capacitors.

3. The trailer of claim 2, wherein the at least one electric motor is configured to slow the trailer by capturing kinetic energy from the trailer, convert the kinetic energy to electrical energy, and charge the power source with the electrical energy.

4. The trailer of claim 1, wherein the control system is configured to use the sensor signals to determine when the trailer is about to spin, skid, or jackknife and to discontinue operation of the at least one electric motor when the control system determines the trailer is about to spin, skid, or jackknife.

5. The trailer of claim 4, further comprising:
trailer brakes, the control system being configured to operate the trailer brakes when the control system determines the trailer is about to spin, skid, or jackknife.

6. The trailer of claim 1, further comprising:
trailer brakes, the control system being configured to use the sensor signals to determine when the trailer is about to spin, skid, or jackknife and to operate the trailer brakes when the control system determines the trailer is about to spin, skid, or jackknife.

7. The trailer of claim 1, wherein the at least one sensor comprises a Hall Effect sensor,
the kingpin assembly comprising a magnet and at least one spring,
the at least one spring biases the magnet away from the Hall Effect sensor,
the at least one spring compresses along a first direction and moves the magnet closer to the Hall Effect sensor when force is applied along the first direction, and
the Hall Effect sensor detects the movement of the magnet and encodes information related to the detected movement in at least one of the sensor signals.

8. The trailer of claim 1, wherein the at least one electric motor assists the towing vehicle when the trailer is coupled to the towing vehicle and drives the plurality of wheels.

9. The trailer of claim 1, wherein the at least one electric motor is configured to propel the trailer without the towing vehicle when the trailer is uncoupled from the towing vehicle.

10. A trailer for use with a towing vehicle comprising a first connector, the trailer comprising:
a connector assembly comprising a second connector and at least one sensor, the second connector being configured to be coupled to the first connector to thereby couple the trailer to the towing vehicle, the at least one sensor being configured to detect forces applied to at least a portion of the connector assembly;
a plurality of wheels; and
a trailer assist assembly comprising a control system and at least one electric motor, the control system being configured to control operation of the at least one electric motor, receive sensor signals from the at least one sensor, and use the sensor signals to determine when to operate the at least one electric motor, the at least one electric motor being operable to drive the plurality of wheels.

11. The trailer of claim 10 for use with the first connector being a fifth wheel hitch, wherein the second connector is a kingpin configured to be received by the fifth wheel hitch.

12. The trailer of claim 10, wherein the trailer assist assembly comprises a power source configured to power the control system and the at least one electric motor; and
the power source comprises batteries and/or capacitors.

13. The trailer of claim 12, wherein the at least one electric motor is configured to slow the trailer by capturing kinetic energy from the trailer, convert the kinetic energy to electrical energy, and charge the power source with the electrical energy.

14. The trailer of claim 10, wherein the control system is configured to use the sensor signals to determine when the trailer is about to spin, skid, or jackknife and to discontinue operation of the at least one electric motor when the control system determines the trailer is about to spin, skid, or jackknife.

15. The trailer of claim 14, further comprising:
trailer brakes, the control system being configured to operate the trailer brakes when the control system determines the trailer is about to spin, skid, or jackknife.

16. The trailer of claim 10, further comprising:
trailer brakes, the control system being configured to use the sensor signals to determine when the trailer is about to spin, skid, or jackknife and to operate the trailer brakes when the control system determines the trailer is about to spin, skid, or jackknife.

17. The trailer of claim 10, wherein the at least one sensor comprises a Hall Effect sensor,
the connector assembly comprising a magnet and at least one spring,
the at least one spring biases the magnet away from the Hall Effect sensor,
the at least one spring compresses along a first direction and moves the magnet closer to the Hall Effect sensor when force is applied along the first direction, and
the Hall Effect sensor detects the movement of the magnet and encodes information related to the detected movement in at least one of the sensor signals.

18. The trailer of claim 10, wherein the at least one electric motor assists the towing vehicle when the trailer is coupled to the towing vehicle and drives the plurality of wheels.

19. The trailer of claim 10, wherein the at least one electric motor is configured to propel the trailer without the towing vehicle when the trailer is uncoupled from the towing vehicle.

20. A trailer configured to be coupled to a towing vehicle at a connection, the trailer comprising:
at least one sensor configured to detect forces at the connection;
a plurality of wheels; and
a trailer assist assembly comprising a control system and at least one electric motor, the control system being configured to cause the at least one electric motor to drive the plurality of wheels, which helps propel the trailer in a drive direction, the control system being configured to monitor sensor signals generated by the at least one sensor and detect when the sensor signals indicate an undesirable change in the forces at the connection, the control system being configured to stop the at least one electric motor from driving the plurality of wheels when the control system detects that the sensor signals indicate the undesirable change in the forces at the connection.

21. The trailer of claim 20, wherein the undesirable change in the forces at the connection indicate that the trailer is about to spin, skid, or jackknife.

22. The trailer of claim 20, wherein the undesirable change is an increase in the forces at the connection that is greater than zero Newtons.

23. The trailer of claim 20 for use with the towing vehicle having a fuel efficiency, wherein the trailer improves the fuel efficiency of the towing vehicle.

24. The trailer of claim 23, wherein the trailer improves the fuel efficiency of the towing vehicle by up to 15% on average.
